(19) United States
(12) Patent Application Publication
(10) Pub. No.: US 2007/0177898 A1
(43) Pub. Date: Aug. 2, 2007

(54) Power transmitter and a developing device driver of image forming apparatus using the same

(75) Inventor: Dae-lim Shin, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/452,945

(22) Filed: Jun. 15, 2006

(30) Foreign Application Priority Data
Jan. 27, 2006 (KR) 2006-8798

(51) Int. Cl. G03G 15/06

(52) U.S. Cl. 399/222

(57) ABSTRACT

A power transmitter, including a driving gear rotated by a driving motor, a driven gear rotatably coupled with the driving gear through a coupler, and a power interruption unit to be broken when the driven gear is overloaded so as to release the coupling between the driven gear and the coupler such that power transmission to the driven gear is cut off.

### CROSS-REFERENCE TO RELATED APPLICATIONS

This application claims the benefit of Korean Application No. 2006-8798, filed Jan. 27, 2006, in the Korean Intellectual Property Office, the disclosure of which is incorporated herein by reference.

### BACKGROUND OF THE INVENTION

1. Field of the Invention

An aspect of the present invention relates to a power transmitter. More particularly, an aspect of the present invention relates to an improved power transmitter that prevents damage of a driver gear by cutting off a transmission of power when a driven unit is overloaded, and a developing device driver using the same.

2. Description of the Related Art

Generally, image forming apparatuses, such as a printer, a photocopier, and a multifunction peripheral, comprise a developing device to form an electrostatic latent image on a photoconductive medium by attaching toner to the photoconductive medium through a developing roller. The developing device, as a consumable part, is detachably mounted to a main body of the image forming apparatus, and is driven by power transmitted from a driver installed in the main body.

FIG. 1 is a perspective view showing a developing device driving unit mounted in a general conventional image forming apparatus. FIG. 2 illustrates a gear connection structure of the developing device driving unit of FIG. 1. As shown in FIGS. 1 and 2, power from a driving motor 10 is transmitted to one of a plurality of driven gears (not shown) provided to a developing device 1, through a shaft gear 10a, first and second gears 21 and 22, and a coupler 25. The plurality of driven gears comprises a developing roller gear, a toner supply roller gear, and an agitator gear. The coupler may be mounted to the agitator gear. The gears are meshed with one another at one side of a main body of the developing device 1.

When the power of the driving motor 10 is transmitted to the agitator gear through the aforementioned path, the developing roller gear and the toner supplying roller gear, being meshed with the agitator gear, are rotated. Accordingly, the developing roller, the toner supplying roller, and the agitator are operated.

However, because the above-described conventional developing device driver is not equipped with a structure to cut off the power transmission, gear teeth of the driver could be damaged due to an overload of the driven gear. More specifically, agitator gears of the agitator, which stirs toner received in the developing device main body, may be overloaded due to unexpected problems, such as a caking of the toner. In this case, excessive torque caused by the overload may be transmitted directly to the driver gear, thereby breaking or damaging the teeth of the driver gear.

### SUMMARY OF THE INVENTION

An aspect of the present invention is to solve at least the above and/or other problems and disadvantages and to provide at least the and/or other advantages described below. Accordingly, an aspect of the present invention is to provide a power transmitter capable of preventing damage to a driver gear by cutting off power transmission when a driven unit is overloaded, and a developing device driver of an image forming apparatus using the same.

In order to achieve the above-described and/or other aspects of the present invention, there is provided a power transmitter, including a driving gear rotated by a driving motor, a driven gear rotatably coupled with the driving gear through a coupler, and a power interruption unit to be broken when the driven gear is overloaded so as to release the coupling between the driven gear and the coupler such that power transmission to the driven gear is cut off.

The power interruption unit comprises at least two connection projections protruded from the driven gear in an axial direction; and a connection member comprises first groove parts into which the two connection projections are inserted and a second groove part to be connected to the coupler, and when an overload over a certain driving torque is applied to the driven gear, at least one of the connection projections is broken.

The connection projections are hollow. A cross-sectional shape of the connection projections is not limited to a certain form. In other words, the connection projections may have substantially circular or polygonal cross-sectional shapes.

According to another aspect of the invention, a developing device driver of an image forming apparatus comprises a driving unit having a driving motor mounted to a main body of the image forming apparatus; a driven unit having a plurality of driven gears provided to a developing device removably mounted to the main body of the image forming apparatus; a coupler interconnecting the driving unit and the driven unit as the developing device is mounted to the main body, to allow for power transmission between the driving unit and the driven unit; and a power interruption unit to break when the driven unit is overloaded so as to release the coupling between the driven unit and the coupler such that the power transmission to the driven unit is cut off.

The power interruption unit comprises at least two connection projections formed at one of the plurality of the driven gears of the driven unit in an axial direction; and a connection member comprises first groove parts into which the two connection projections are inserted and a second groove part to be connected to the coupler, and when an overload over a certain driving torque is applied to the driven gear, at least one of the connection projections is broken.

The plurality of driven gears comprises a developing roller gear, a toner supplying roller gear and an agitator gear, and the connection projection is integrally formed with the agitator gear.

The driving unit comprises a first driving gear meshed with a shaft gear of the driving motor; and a second driving gear, rotated by the first driving gear, being coupled with the coupler.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view schematically showing a developing device driving unit provided to a general image forming apparatus;

FIG. 2 is a view showing a gear connection structure of the developing device driving unit of FIG. 1;

FIG. 3 is an exploded perspective view schematically showing a developing device driver of an image forming apparatus, according to an embodiment of the present invention;

FIG. 4A is a perspective view of a driven gear having a connection projection, which is the essential element of the present invention, according to one embodiment of the present invention;

FIG. 4B is a perspective view of a driven gear having a connection projection according to another embodiment of the present invention;

FIG. 5 is a perspective view showing a state wherein the driven gear having the connection projection which is the essential element of the present invention is engaged with a connection member.

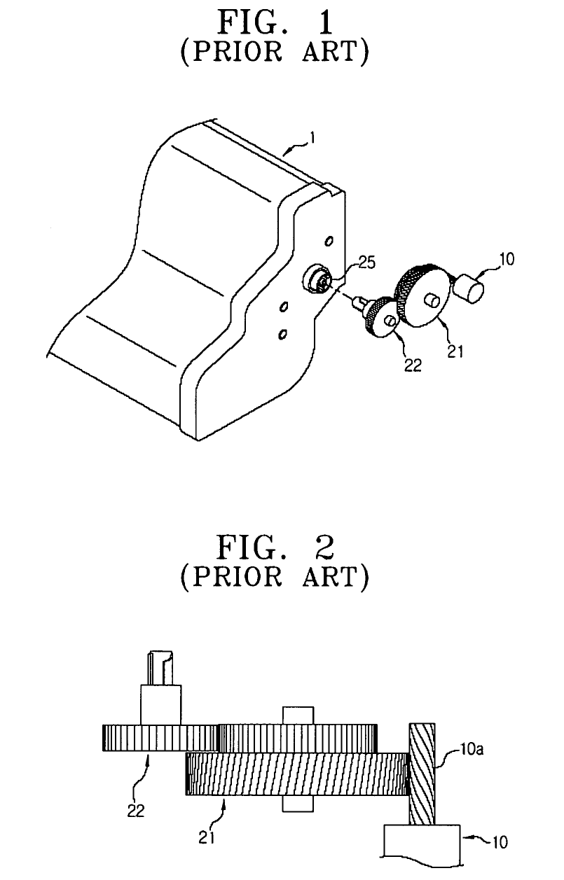

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

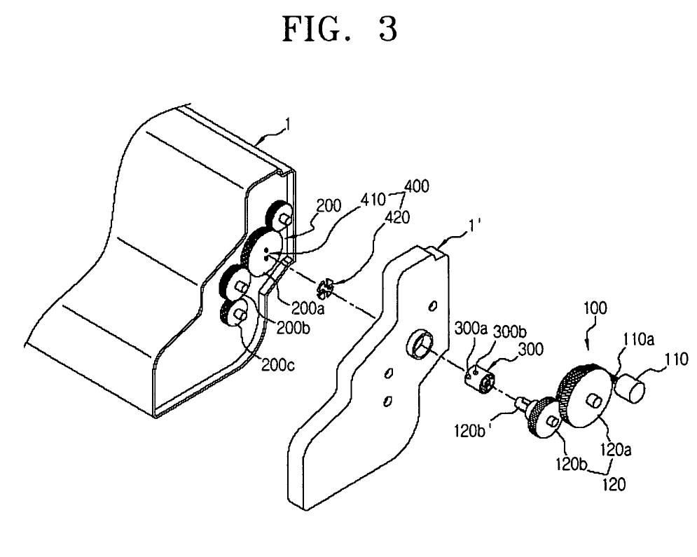

Referring to FIGS. 3 through 5, a developing device driver of an image forming apparatus comprises a driving unit 100, a driven unit 200, a coupler 300, and a power interruption unit 400. The driving unit 100 comprises a driving motor 110 mounted to a main body (not shown) of the image forming apparatus, and a driving gear 120 that is rotated by the driving motor 110. The driving gear 120 comprises a first driving gear 120a that is meshed with a shaft gear 110a of the driving gear 110, and a second driving gear 120b rotated by the first driving gear 120a. The second driving gear 120b is coupled to the coupler 300.

The driven unit 200 comprises a plurality of driven gears 200a, 200b and 200c provided to a developing device 1 removably mounted to the main body of the image forming apparatus. The plurality of driven gears 200a, 200b and 200c include a developing roller gear, a toner supplying roller gear, and an agitator gear. The driven gears 200a, 200b and 200c are shielded by a side plate 1′ mounted to the developing device 1.

The coupler 300 interconnects the driving unit 100 and the driven unit 200 when the developing device 1 is mounted to the main body and provides for power transmission between the driving unit 100 and the driven unit 200. The coupler 300 is coupled with a shaft part 120b′ of the second driving gear 120b on one side of the coupler 300, and with the driven unit 200 on the other side of the coupler 300.

The power interruption unit 400 comprises a connection projection 410, which, according to embodiments discussed below, may resemble a hollow cylinder, formed at one of the plurality of driven gears 200a, 200b or 200c of the driven unit 200, and a connection member 420, which, according to embodiments discussed below, may resemble a clover, and which is connected with the one driven gear 200a, 200b or 200c at which the connection projection 410 is formed.

In accordance with an embodiment of the invention, the connection projection 410 is inserted into a first groove part 420a. When the driven unit 200 is overloaded with more than a certain amount of driving torque by the driving motor 110, the connection projection 410 of the power interruption unit 400 is broken. As a result the coupling between the driven unit 200 and the coupler 300 is released and power transmission is cut off.

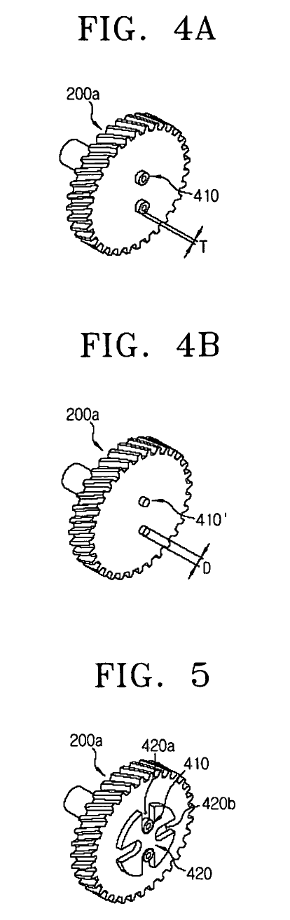

As shown in the illustration of the embodiment in FIG. 4A, at least two connection projections 410 are formed at one of the driven gears 200a, 200b or 200c, for example, on one side of the agitator gear 200a in an axial direction. The connection projection 410 has a hollow bushing form. A cross-sectional shape of the connection projection 410 may have various polygonal or circular shapes. The connection projection 410 has a thickness T that allows the connection projection 410 to be breakable upon overload of a certain degree of driving torque, which is applied to the driven unit 200 by the driving motor 110.

More particularly, in an experiment performed with a high-speed multifunction apparatus having 45 ppm, under the condition wherein the torque of the driving motor 110 is 2 kgf·cm, and 15˜20 kgf·cm of overloading torque is generated from the driven unit 200, it has been shown that, when the thickness T of the connection projection 410 is set to 0.6˜0.8 mm, the connection projection 410 breaks. In other words, the thickness of the connection projection 410 should be based on a tendency of the connection projection 410 to break and to release the coupling between the driven unit 200 and the coupler 300 when the driven unit 200 is overloaded, so that the power transmission to the driven unit 200 is cut off.

In accordance with embodiments of the invention, as shown in FIG. 4B, the connection projection 410′ may be a solid cylinder (as opposed to a hollow cylinder). In addition, the diameter D of the connection projection 410′ may be designed to provide the connection projection 410′ with a tendency to break as a result of an overload applied to the driven unit 200.

As shown in FIG. 5, the connection member 420 is engaged with the one driven gear 200a that is provided with the connection projection 410. According to an embodiment of the invention, the connection member 420 has a disc form having a predetermined area. In addition, the connection member 420 comprises first groove parts 420a into which two connection projections 420 may be inserted and second groove parts 420b into which two coupler projections 300a and 300b formed on the coupler 300 may be inserted. It is understood that the first and second groove parts 420a and 420b may be singular and that only one of the coupler projections 300a and 300b may be provided. The first and the second groove parts 420a and 420b are arranged perpendicularly to each other, on an outer surface of the connection member 420.

The above-structured developing device driver of an image forming apparatus operates as follows. The power from the driving motor 110 is transmitted to one of the plurality of driven gears 200a, 200b and 200c provided to the developing device 1 through the shaft gear 110a, the first and the second driving gears 120a and 120b, and the coupler 300. For example, assuming that the power is transmitted to the agitator gear 200a, the toner supplying roller gear 200b and the developing roller gear 200c, being meshed with the agitator gear 200a, are rotated together. Accordingly, the developing roller, the toner supplying roller, and the agitator perform predetermined operations. Here, the agitator stirs the toner received in a main body of the developing device 1. When problems, such as toner caking, occur, the agitator gear 200a of the driven unit 200 may be overloaded. When the driven unit 200 is thus overloaded due to the abnormal operation of the developing device 1, the connection projection 410 is broken so that the coupling between the driven unit 200 and the coupler 300 is released, thereby cutting off the power transmission. As a result, damage to the driving unit 100 may be prevented.

As may be appreciated from the above description, according to the embodiments of the present invention, the gears of the driving unit 100 may be prevented from being damaged by the driven unit 200 overloaded, by a cutting off of power being transmitted from the driving unit 100 when an overloading condition is generated.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A power transmitter, comprising:
a driving gear rotated by a driving motor;
a driven gear rotatably coupled with the driving gear through a coupler; and
a power interruption unit to be broken when the driven gear is overloaded so as to release the coupling between the driven gear and the coupler such that power transmission to the driven gear is cut off.

2. The power transmitter of claim 1, wherein the power interruption unit comprises:
at least two connection projections protruded from the driven gear in an axial direction; and
a connection member, including a first groove part into which the at least two connection projections are inserted and a second groove part to connect to the coupler, wherein, when an overload over a certain driving torque is applied to the driven gear, at least one of the connection projections and/or the connection member breaks.

3. The power transmitter of claim 2, wherein the connection projections are hollow.

4. The power transmitter of claim 3, wherein the connection projections have substantially circular or polygonal cross-sectional shapes.

5. The power transmitter of claim 2, wherein the connection projections are solid.

6. The power transmitter of claim 5, wherein the connection projections have substantially circular or polygonal cross-sectional shapes.

7. A developing device driver of an image forming apparatus, comprising:
a driving unit having a driving motor mounted to a main body of the image forming apparatus;
a driven unit having a plurality of driven gears provided to a developing device removably mounted to the main body of the image forming apparatus;
a coupler interconnecting the driving unit and the driven unit as the developing device is mounted to the main body, to allow for power transmission between the driving unit and the driven unit; and
a power interruption unit to break when the driven unit is overloaded so as to release the coupling between the driven unit and the coupler such that the power transmission to the driven unit is cut off.

8. The developing device driver of claim 7, wherein the power interruption unit comprises:
at least two connection projections protruded from the driven gear in an axial direction; and
a connection member, including a first groove part into which the at least two connection projections are inserted and a second groove part to connect to the coupler, wherein, when an overload over a certain driving torque is applied to the driven gear, at least one of the connection projections and/or the connection member breaks.

9. The developing device driver of claim 8, wherein the plurality of driven gears comprises a developing roller gear, a toner supplying roller gear and an agitator gear, and wherein the connection projections are integrally formed with the agitator gear.

10. The developing device driver of claim 9, wherein the driving unit comprises:
a first driving gear meshed with a shaft gear of the driving motor; and
a second driving gear to rotate with the first driving gear, and to be coupled with the coupler.

11. The developing device driver of claim 10, wherein the connection projections are hollow.

12. The developing device driver of claim 11, wherein the connection projections have substantially circular or polygonal cross-sectional shapes.

13. The developing device driver of claim 10, wherein the connection projections are solid.

14. The developing device driver of claim 13, wherein the connection projections have substantially circular or polygonal cross-sectional shapes.

15. A developing device driver of an image forming apparatus in which power from a driving motor, which is normally transmitted to a driven gear on the developing device through a coupler coupled to the driven gear, is cut off when the coupling between the coupler and the driven gear is broken as a result of an overload of driving torque provided by the driving motor.
